(19) United States
(12) Patent Application Publication
(10) Pub. No.: US 2025/0256843 A1
(43) Pub. Date: Aug. 14, 2025

(54) CONNECTED KITE

(71) Applicant: TOYOTA JIDOSHA KABUSHIKI KAISHA, Toyota-shi (JP)

(72) Inventors: Taro Tsukada, Sunto-gun (JP); Aya Hamajima, Sunto-gun (JP); Yushi Seki, Ashigarakami-gun (JP); Tateru Fukagawa, Fujisawa-shi (JP); Eiji Itakura, Gotemba-shi (JP)

(73) Assignee: TOYOTA JIDOSHA KABUSHIKI KAISHA, Toyota-shi (JP)

(21) Appl. No.: 19/024,326

(22) Filed: Jan. 16, 2025

(30) Foreign Application Priority Data
Feb. 9, 2024 (JP) 2024-018583

(51) Int. Cl. B64C 31/06; F03D 5/00

(52) U.S. Cl. CPC B64C 31/06; F03D 5/015

(57) ABSTRACT

A connected kite in which a plurality of kites are connected in a separable manner. The connected kite can improve space utilization.

### CROSS-REFERENCE TO RELATED APPLICATIONS

This application is based upon and claims the benefit of priority of the prior Japanese Patent Application No. 2024-018583, filed on Feb. 9, 2024, the entire contents of which are incorporated herein by reference.

### BACKGROUND

### 1. Technical Field

The present invention relates to a connected kite.

### 2. Description of the Related Art

This type of kite is sometimes used for wind power generation. For example, a Patent Literature 1 (i.e., Japanese Patent Application Laid Open No. 2016-537233) discloses an aircraft equipped with a wind power generation unit.

A flying attitude of a kite during flight changes according to at least one of changes in wind direction and wind speed. For this reason, when a plurality of kites are flying, it is necessary to secure a space for each kite to fly without interfering with the other kites to prevent one kite from colliding with the other kites or to prevent the tether that anchors one kite from getting tangled with the tether that anchors the other kites, for example. Moreover, an open area without objects (e.g., buildings, trees) that may be obstacles to flight of a kite is required in order to fly a kite (in other words, to take off a kite). As a result, the space occupied by one kite is significantly larger than the size of the kite. In other words, there is a technical problem that the space utilization rate is relatively low.

### SUMMARY

In view of the problem described above, for example, it is therefore an object of the present invention to provide a connected kite which can improve space utilization.

A connected kite of one aspect of the present invention is a connected kite in which a plurality of kites are connected in a separable manner.

### BRIEF DESCRIPTION OF THE DRAWINGS

FIG. 1 is a diagram illustrating one example of a connected kite according to an embodiment.

FIG. 2 is a diagram illustrating one example of a connecting method of kites.

FIG. 3 is a diagram illustrating another example of a connecting method of kites.

FIGS. 4A and 4B are diagrams for explaining effect of a connected kite according to an embodiment.

FIG. 5 is a diagram illustrating another example of a connected kite according to an embodiment.

### DETAILED DESCRIPTION OF THE EMBODIMENT

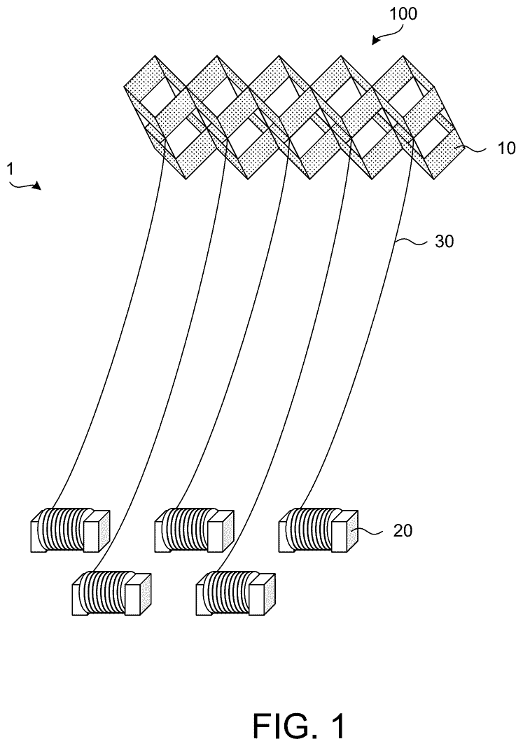

An embodiment of a connected kite will be described with reference to FIGS. 1 to 4B. In FIG. 1, a connected kite 100 is formed by connecting a plurality of kites 10 to each other in a separable manner (in other words, in a separable aspect). Each of the plurality of kites 10 is moored to a mooring apparatus 20 through a tether 30. The mooring apparatus 20 may include a drum around which the tether 30 is wrapped. In the present embodiment, the power generation system 1 may be constituted by the connected kite 100 (i.e., the plurality of kite 10) and the plurality of mooring apparatuses 20. Incidentally, the configuration of each of the kite 10 and the connected kite 100 shown in FIG. 1 is an example, it is not intended to be limited thereto. Incidentally, the tether 30 may be referred to as a mooring line.

For example, the mooring apparatus 20 may include a motor for rotating the drum around which the tether 30 is wound and a generator. Wherein the mooring apparatus 20 may have a motor generator that functions as a motor and functions as a generator, instead of the motor and the generator. When the kite 10 (specifically, the connected kite 100) is raised, the tether 30 is fed out from the drum of the mooring apparatus 20 with raising the kite 10. The drum rotates due to the unwinding operation of the tether 30. Generating power may be performed by the generator rotating with the rotation of the drum.

The tether 30 is unwound to a predetermined length or, after a predetermined amount of time has elapsed, the drum is rotated in a direction to wind the tether 30 by the motor possessed by the mooring apparatus 20. As a result, the kite 10 (specifically, the connected kite 100) is lowered due to the winding operation of the tether 30.

In the power generation system 1, power generation may be performed by repeatedly performing the unwinding operation and the winding operation of the tether 30. In other words, in the power generation system 1, the tethered wind power generation using the connected kite 100 may be performed.

For example, at least one kite 10 of the plurality of kite 10 constituting the connected kite 100 may have a solar panel. In this case, in the power generation system 1, solar photovoltaic power generation using the solar panel mounted on at least one kite 10 may be performed. If at least one mooring apparatus 20 of the plurality of mooring apparatus 20 has a generator, the solar photovoltaic power generation and the tethered wind power generation may be performed in the power generation system 1.

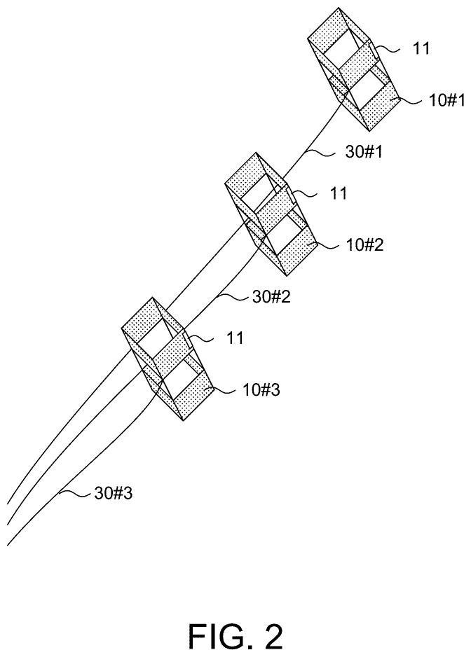

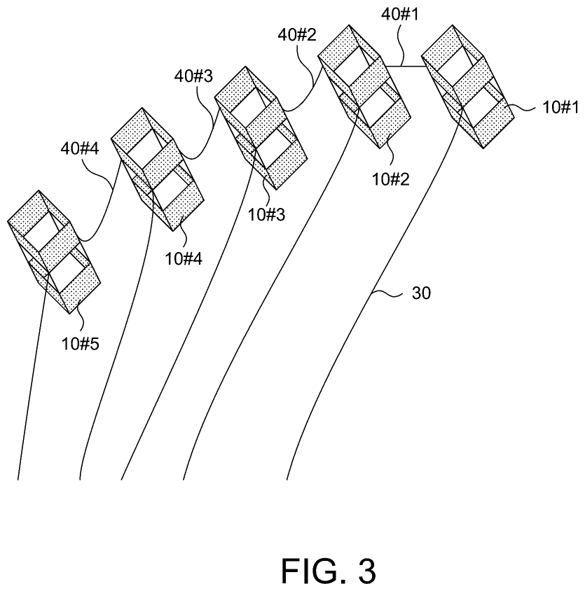

Next, a connecting method of the plurality of the kite 10 will be described with reference to FIGS. 2 and 3. The connecting method described below is an example, not intended to be limited thereto.

A first aspect of the connecting method will be described with reference to FIG. 2. In FIG. 2, first, a kite 10 #1 is assumed to be raised. After the kite 10 #1 is raised (in other words, during the flight of the kite 10 #1), a kite 10 #2 is raised. At this time, a tether 30 #1 may function as a guide of the kite 10 #2. As a result, the kite 10 #2 is raised along the tether 30 #1 mooring the kite 10 #1. If the kite 10 #2 reaches the vicinity of the kite 10 #1, the kite 10 #1 and the kite 10 #2 may be connected by couplers 11 provided on the kite 10 #1 and the kite 10 #2. In FIG. 2, in order to avoid complication of the drawings, it illustrates one coupler 11 to one kite 10, each kite 10 may have a plurality of couplers 11.

After the kite 10 #2 is raised, a kite 10 #3 is raised. At this time, the tether 30 #2 may function as a guide of the kite 10 #3. As a result, the kite 10 #3 is raised along a tether 30 #2 mooring the kite 10 #2. When the kite 10 #3 reaches the vicinity of the kite 10 #2, the kite 10 #2 and the kite 10 #3 may be connected by couplers 11 provided on the kite 10 #2 and the kite 10 #3. Incidentally, a timing, at which the kite 10 #3 is raised, may be a timing after connecting the kite 10 #2 with the kite 10 #2, or a timing before connecting the kite 10 #2 with the kite 10 #1.

The coupler 11 may be, for example, at least one of an electromagnet, a mechanical coupling and a hook-and-loop fastener. In other words, the coupler 11 may be an electro-magnetic coupling unit or may be a mechanical coupling unit. Here, the electromagnet loses magnetic force by energization is stopped. Therefore, by stopping the energization of the electromagnet, it is possible to separate connected two kites (e.g., the kite 10 #1 and the kite 10 #2). Moreover, the mechanical coupling and the hook-and-loop fasteners are mechanically couplable and mechanically separable. For this reason, two kites, which are connected by at least one of the mechanical coupling and the hook-and-loop fasteners, are separable. Wherein the mechanical coupling and the hook-and-loop fastener may be referred to as a reversible coupling apparatus. Incidentally, the coupler 11 may have the function of both the electro-magnetic coupling unit and the mechanical coupling unit. For example, the coupler 11 may include an electromagnet and a hook-and-loop fastener. In this case, two kites (e.g., kites 10 #1 and 10 #2) may be coupled by both the electromagnet and the hook-and-loop fastener.

A second aspect of the connecting method will be described with reference to FIG. 3 In FIG. 3, before the plurality of kites 10 #1, 10 #2, 10 #3, 10 #4, and 10 #5 are raised, for example, the kite 10 #1 and the kite 10 #2 are connected by a tether 40 #1, the kite 10 #2 and the kite 10 #3 are connected by a tether 40 #2, the kite 10 #3 and the kite 10 #4 are connected by a tether 40 #3, and the kite 10 #4 and the kite 10 #5 are connected by a tether 40 #4. Incidentally, the tether 40 #1, 40 #2, 40 #3 and 40 #4 are tethers different from the tethers 30 for mooring the plurality of kites 10 #1, 10 #2, 10 #3, 10 #4 and 10 #5.

For example, after the kite 10 #1 is raised (in other words, during the flight of the kite 10 #1), the kite 10 #2 may be raised. After the kite 10 #2 is raised, the kite 10 #3 may be raised. After the kite 10 #3 is raised, the kite 10 #4 may be raised. After the kite 10 #4 is raised, the kite 10 #5 may be raised.

After the kites 10 #1 and 10 #2 are raised (in other words, during the flight of the kites 10 #1 and 10 #2), the tether 40 #1 may be wound, thereby the kite 10 #1 and the kite 10 #2 may be connected. After the kites 10 #2 and 10 #3 are raised (in other words, during the flight of the kites 10 #2 and 10 #3), the tether 40 #2 is wound, thereby the kite 10 #2 and the kite 10 #3 may be connected. After the kites 10 #3 and 10 #4 are raised (in other words, during the flight of the kites 10 #3 and 10 #4), the tether 40 #3 is wound, thereby the kite 10 #3 and the kite 10 #4 may be connected. After the kites 10 #4 and 10 #5 are raised (in other words, during the flight of the kites 10 #4 and 10 #5), the tether 40 #4 is wound, thereby the kite 10 #4 and the kite 10 #5 may be connected.

Incidentally, the kite 10 (e.g., the kites 10 #1, 10 #2, 10 #3, 10 #4 and 10 #5) may have a winch having a drum wounding the tether 40 (e.g., the tethers 40 #1, 40 #2, 40 #3 and 40 #4). For example, winding of tethers 40 #1, 40 #2, 40 #3 and 40 #4 may be performed by the winches.

Incidentally, after the connected kite 100 is formed by connecting the plurality of kites 10, the tether 30 for mooring a part of kite 10 of the plurality of kite 10 may be disconnected from the kite 10 or mooring apparatus 20. In this case, the number of tethers 30 mooring the connected kite 100 may be less than the number of the plurality of kites 10 constituting the connected kite 100. The kite 10 is not limited to having the solar panel described above, for example, a camera, a sensor or the like may be mounted. In other words, the kite 10 may have a mounted object.

### Technical Effect

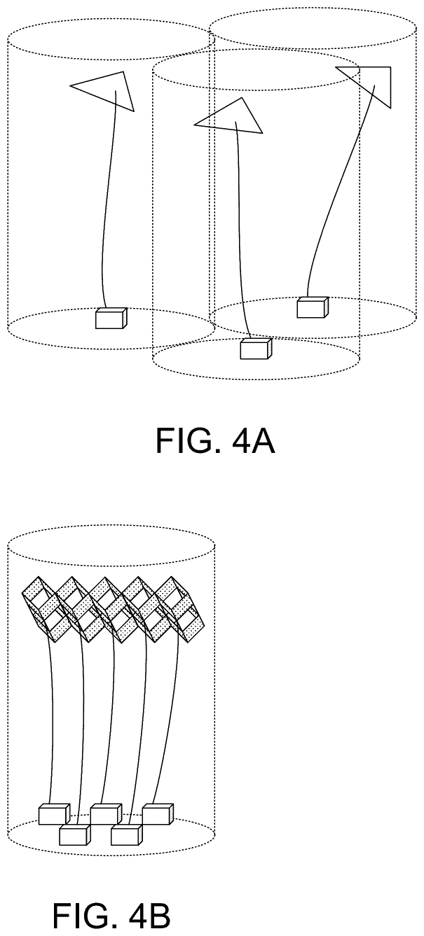

Technical effect of the connected kite 100 according to the embodiment will be described with reference to FIGS. 4A and 4B When each of the plurality of kites flies independently, it is necessary to prevent the collision between kites and entanglement of the tether. Therefore, for example, as shown in FIG. 4A, it is necessary to secure the space each kite can fly safely (see cylindrical dotted line in FIG. 4A). As a result, the space occupied by a kite becomes significantly larger than the size of the kite. In contrast, in the connected kite 100, since the plurality of kites 10 flies together, it is possible to prevent the collision between kites 10 constituting the connected kite 100, it is possible to suppress the occurrence of entanglement of the tether 30.

In order to rise the kite (in other words, take off the kite), it is necessary to have open land free of objects (e.g., buildings, wood) that could obstruct the kite's flight. The area of the land required to lift kite is directly proportional to the wing area of a kite. Therefore, when a single kite, which has the same wing area as the connected kite 100, is raised, a wider land than the land required for raising the kite 10 is required. In this embodiment, for example, as described with reference to FIGS. 2 and 3, after raising each kite 10, in the sky (i.e., during the flight of each kite 10), each kite 10 is coupled. Therefore, in the present embodiment, it is possible to fly the connected kite 100 in a narrower land than is required when the single kite, which has the same wing area as the connected kite 100, is raised.

As a result of the above, in the present embodiment, it is possible to fly the connected kite 100 in which the plurality of kites 10 are connected in a space, in which the single kite 10 can fly safely (see cylindrical dotted line in FIG. 4B). In other words, according to the connected kite 100 of the present embodiment, it is possible to improve the space utilization.

### Modification

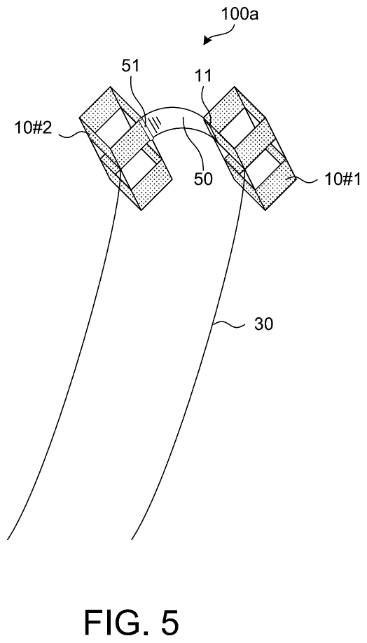

A modification of the connected kite of the embodiment will be described with reference to FIG. 5. As shown in FIG. 5, the connected kite 100a according to the modification is formed by connecting the plurality of kite 10 (e.g., the kites 10 #1 and 10 #2) separably. For example, the kite 10 #2 may have a membrane storage apparatus 51 for storing the membrane 50. A coupler 11 may be attached to one end of the membrane 50.

For example, after the kite 10 #1 and the kite 10 #2 are connected by the coupler 11, the membrane 50 may be pulled out from the membrane storage apparatus 51 due to the force of the wind received by each of the kites 10 #1 and 10 #2. Alternatively, after the kite 10 #1 and kite 10 #2 are connected by the coupler 11, the membrane 50 is delivered from the membrane housing apparatus 51 by a motor provided on the membrane housing apparatus 51, thereby the membrane 50 may be deployed.

According to the connected kite 100a of the modification, it is possible to enlarge the wing area of the connected kite 100a.

Aspects of the invention derived from the embodiments and modifications described above will be described below.

A connected kite of one aspect of the present invention is a connected kite in which a plurality of kites are connected in a separable manner. Two or more kites of the plurality of kites may be moored to mooring apparatuses. At least one kite of the plurality of kites may have a mounted object. Wherein, examples of the mounted object include the solar panels, cameras and sensors described above. At least a part of the plurality of kites may be mechanically connected. At least a part of the plurality of kites may be electromagnetically connected.

The present invention is not limited to the above-described embodiments, but can be appropriately modified in range which is not contrary to the gist or the philosophy of the invention which can be read from range and the specification of the patent claim, and the connected kite accompanied by such modifications is also included in the technical range of the present invention.

What is claimed is:

1. A connected kite in which a plurality of kites are connected in a separable manner.

2. The connected kite according to claim 1, wherein
two or more kites of the plurality of kites are moored to mooring apparatuses.

3. The connected kite according to claim 1, wherein
at least one kite of the plurality of kites has a mounted object.

4. The connected kite according to claim 1, wherein
at least a part of the plurality of kites are mechanically connected.

5. The connected kite according to claim 1, wherein
at least a part of the plurality of kites are electromagnetically connected.
